(19) United States
(12) Patent Application Publication
(10) Pub. No.: US 2016/0034281 A1
(43) Pub. Date: Feb. 4, 2016

(54) INSTRUCTION PROCESSING SYSTEM AND METHOD

(71) Applicant: SHANGHAI XINHAO MICROELECTRONICS CO. LTD., Yangpu, Shanghai (CN)

(72) Inventor: KENNETH CHENGHAO LIN, Shanghai (CN)

(21) Appl. No.: 14/766,755

(22) PCT Filed: Jan. 29, 2014
(86) PCT No.: PCT/CN2014/071767

§ 371 Date: Aug. 9, 2015

(30) Foreign Application Priority Data
Feb. 8, 2013 (CN) 201310050850.8

(51) Int. Cl. G06F 9/38

(52) U.S. Cl. CPC G06F 9/3844; G06F 9/3806

(57) ABSTRACT

An instruction processing system is provided. The system includes a central processing unit (CPU), a memory system and an instruction control unit. The CPU is configured to execute one or more instructions of the executable instructions. The memory system is configured to store the instructions. The instruction control unit is configured to, based on location of a branch instruction stored in a track table, control the memory system to provide the instructions to be executed for the CPU. Further, the instruction control unit is also configured to, based on branch prediction of the branch instruction stored in the track table, control the memory system to output one of a fall-through instruction and a target instruction of the branch instruction.

### TECHNICAL FIELD

The present invention generally relates to computer architecture and, more particularly, to the systems and methods for instruction processing.

### BACKGROUND ART

In today's computer architecture, the performance of a processor is improved mainly by increasing processor frequency. However, with the increase in the number of transistors integrated in a chip, power consumption and heat dissipation problems become more severe. The method of only increasing the processor frequency is difficult to adapt to the development of the processor. In this case, a simple and effective processor pipeline control method may be needed to improve the efficiency in instruction execution. In other words, instruction pipeline control can be implemented by fewer hardware resources, thereby achieving higher instruction throughput.

In pipelining techniques, execution of each instruction is split into a sequence of dependent stages. Each pipeline stage can complete partial function of the instruction. When multiple instructions are executed simultaneously, different stages of multiple instructions may be executed simultaneously. Correspondingly, the pipelining enables one instruction takes multiple clock cycles to complete (or generate an execution result). Whether or not a branch instruction takes a branch determines whether the next instruction segment after the branch instruction or the branch target instruction segment of the branch instruction is executed. That is, before determination information indicating whether a branch is taken is generated, the next instruction segment to be executed cannot be determined.

### DISCLOSURE OF INVENTION

### Technical Problem

For the above problem, one solution is that, before the execution result of the branch instruction is generated, the pipeline is paused and, after branch determination information is generated, a subsequent instruction is fetched and executed. This solution may increase waiting time of a pipeline, reducing overall performance.

Another solution is that the pipeline is not paused, but speculatively selects one from the next instruction segment and a target instruction segment to continue to execute. When the branch determination information is generated, whether the previous speculation is correct may be determined. If the previous speculation is correct, based on the speculative execution instruction segment, subsequent instruction segment continues to be executed; if the previous speculation is incorrect, the execution result of the incorrectly executed instruction segment needs to be cleared and the correct instruction segment is executed. The pipeline is not interrupted by using this method, but the requirement for accuracy of speculation is high. In existing technologies, costly hardware overhead (that is, adding more extra hardware resources) needs to be spent in order to achieve a substantially high branch prediction accuracy rate. Conversely, if the hardware cost is not substantially high or is low, the branch prediction accuracy rate is low. If the speculation is incorrect, overall performance is reduced.

### Solution to Problem

### Technical Solution

The disclosed system and method are directed to solve one or more problems set forth above and other problems.

One aspect of the present disclosure includes an instruction processing system. The system includes a central processing unit (CPU), a memory system and an instruction control unit. The CPU is configured to execute one or more instructions of the executable instructions. The memory system is configured to store the instructions. The instruction control unit is configured to, based on the location of a branch instruction stored in a track table, control the memory system to provide the instructions to be executed for the CPU. Further, the instruction control unit is also configured to, based on branch prediction of the branch instruction stored in a track table, control the memory system to output one of a fall-through instruction and a target instruction of the branch instruction.

Another aspect of the present disclosure includes an instruction processing method. The method includes storing instructions in a memory system, executing one or more instructions of the instructions stored in the memory system and, based on branch prediction of a branch instruction stored in a track table, controlling the memory system to output one of a fall-through instruction of the branch instruction and a target instruction of the branch instruction.

Other aspects of the present disclosure can be understood by those skilled in the art in light of the description, the claims, and the drawings of the present disclosure.

### Advantageous Effects of Invention

### Advantageous Effects

In the instruction processing system provided in the present disclosure, based on the branch prediction bit of the branch instruction stored in a track table, the instruction control unit controls memory system to provide the instructions most likely to be executed for CPU core. A very high branch prediction accuracy rate is achieved with very low hardware costs, thereby improving the performance of the instruction processing system. Other advantages and applications are obvious to those skilled in the art.

The disclosed systems and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

### BRIEF DESCRIPTION OF DRAWINGS

### Description of Drawings

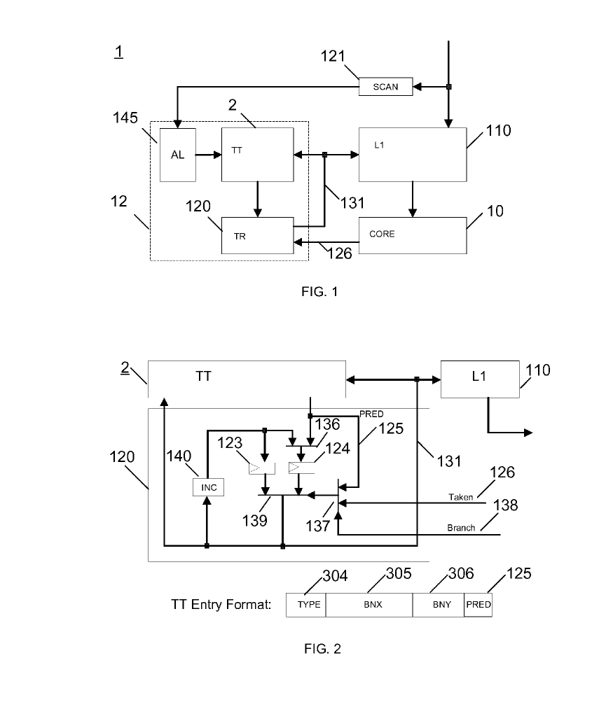

FIG. 1 illustrates a structure schematic diagram of an exemplary instruction processing system consistent with the disclosed embodiments;

FIG. 2 illustrates a structure schematic diagram of an exemplary tracker consistent with the disclosed embodiments;

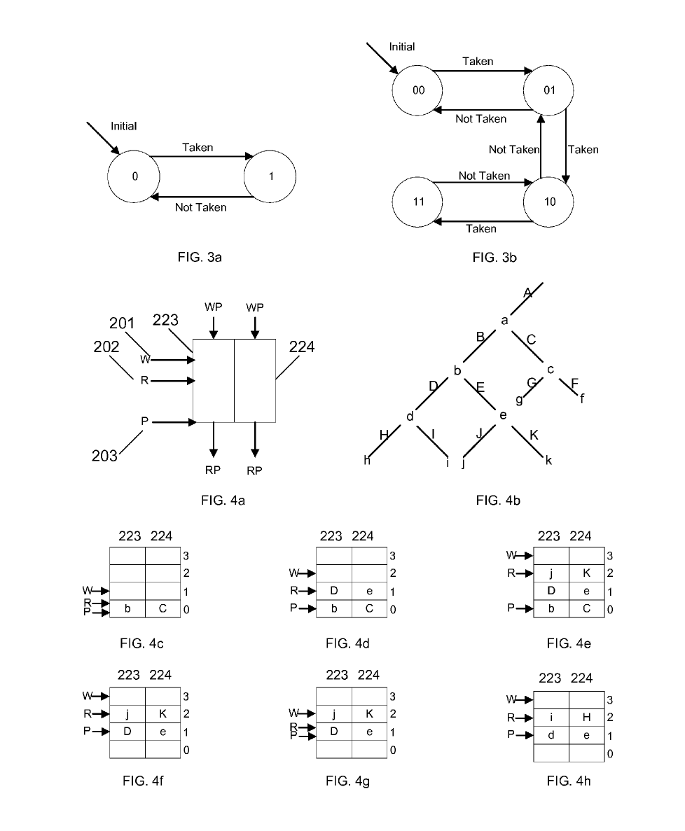

FIG. 3a-3b illustrate a schematic diagram of an exemplary prediction bit consistent with the disclosed embodiments;

FIG. 4a illustrates a structure schematic diagram of a first-in-first-out (FIFO) buffer consistent with the disclosed embodiments;

FIG. 4b illustrates a schematic diagram of an exemplary prediction and execution of an instruction segment consistent with the disclosed embodiments;

FIG. 4c-4h illustrate a structure schematic diagram of the locations pointed to by a read pointer, a writer pointer, and a reserve pointer of buffers and change situation of cell values of buffers at different time points consistent with the disclosed embodiments;

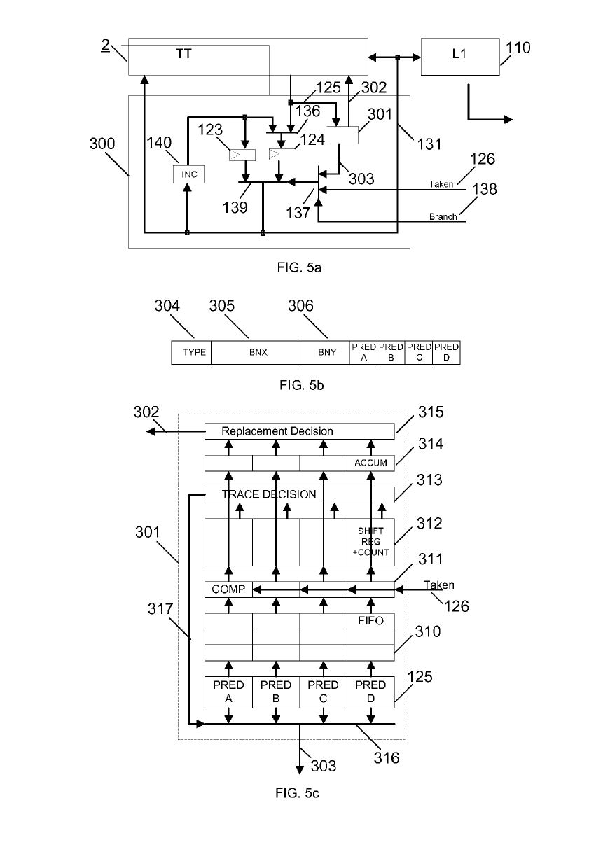

FIG. 5a illustrates a structure schematic diagram of an exemplary tracker with a plurality of groups of prediction bits consistent with the disclosed embodiments;

FIG. 5b illustrates a schematic diagram of the content of an exemplary track point containing a plurality of groups of prediction bits consistent with the disclosed embodiments; and

FIG. 5c illustrates a structure schematic diagram of an exemplary prediction module consistent with the disclosed embodiments.

### BEST MODE FOR CARRYING OUT THE INVENTION

### Best Mode

FIG. 2 illustrates an exemplary preferred embodiment(s).

### MODE FOR THE INVENTION

### Mode for Invention

Reference will now be made in detail to exemplary embodiments of the invention, which are illustrated in the accompanying drawings. The same reference numbers may be used throughout the drawings to refer to the same or like parts.

FIG. 1 illustrates a structure schematic diagram of an exemplary instruction processing system consistent with the disclosed embodiments. As shown in FIG. 1, the instruction processing system may include a CPU core 10, an active list 145, a scanner 121, a track table 2, a tracker 120, and a level one cache 110 (i.e., L1 cache, a first level memory, that is, a memory with the fastest access speed). It is understood that the various components are listed for illustrative purposes, other components may be included and certain components may be combined or omitted. Further, the various components may be distributed over multiple systems, may be physical or virtual components, and may be implemented in hardware (e.g., integrated circuit), software, or a combination of hardware and software.

The central processing unit (CPU) core 10 is configured to execute one or more instructions of executable instructions. The level one cache 110 (i.e., L1 cache, that is, a memory with the fastest access speed) is configured to store the instructions.

The instruction control unit 12 is configured to, based on the location of the branch instruction stored in a track table, control L1 cache to provide the instructions to be executed for CPU core 10.

The instruction control unit 12 includes the track table 2 containing a plurality of track table rows, each table row corresponding to a track. The track table 2 stores the location of the branch instruction stored in the L1 cache 110.

Before CPU core 10 generates execution result of certain branch instruction, based on prediction information stored in instruction control unit 12, instruction control unit 12 may provide the next instruction segment of the branch instruction or the instruction in the target instruction segment of the branch instruction for CPU core 10 to execute. That is, according to value of branch judgment prediction bit of branch instruction (that is, prediction when a branch instruction takes a branch) stored in the track table, instruction control unit 12 controls L1 cache 110 to output possibly executed instructions for processor 10, making CPU core 10 to continue to obtain instructions for processing, thereby avoiding pipeline stalls caused by waiting for branch judgment.

Thus, instruction execution capacity of processor 10 can be fully utilized, improving performance of instructions execution of instruction processing system 1. Based on the received execution result 126 of the branch instruction, instruction control unit 12 verifies whether the prediction of branch judgment is correct. If the prediction is correct, the instruction continues to be executed. If the prediction is incorrect, the process is returned to other instruction segment of the branch instruction to execute.

Specifically, instruction control unit 12 also includes an active table 145. A total entry number of active list 145 is the same as a total cache block number of L1 cache 110 such that a one-to-one relationship can be established between entries in active list 145 and cache blocks in L1 cache 110. Every entry in active list 145 corresponds to one BNX, indicating the position of the cache block stored in L1 cache 110 corresponding to the row of active list 145, thus a one-to-one relationship can be established between BNX and cache block in L1 cache 110. Each entry in active list 145 stores a block address of the L1 cache block.

A branch instruction or a branch point, as used herein, refers to any appropriate type of instruction which may cause CPU core 10 to change an execution flow (e.g., executing an instruction out of sequence). A branch source may refer to an instruction that is used to execute a branch operation (i.e., a branch instruction), and a branch source address may refer to the address of the branch instruction itself. A branch target may refer to a target instruction being branched to when the branch instruction takes a branch, and a branch target address may refer to the address being branched to if the branch is taken successfully, that is, an instruction address of the branch target instruction. A current instruction may refer to an instruction being currently executed or fetched by CPU core 10. A current instruction block may refer to an instruction block containing an instruction being currently executed by CPU core 10. A next instruction or fall-through instruction may refer to the next instruction of the branch instruction if the branch of the branch instruction is not taken or is not taken successfully.

The rows in track table 2 and cache blocks in L1 cache 110 may be in one-to-one correspondence. In general, the memory that is closest to the CPU refers to the memory with the fastest speed, such as level one cache (L1 cache).

The track table 2 contains a plurality of track points. A track point is a single entry in the track table 2 containing information of at least one instruction, such as instruction type information, branch target address, etc.

As used herein, a track address of the track point is a track table address of the track point itself, and the track address is constituted by a row number and a column number. The track address of the track point corresponds to the instruction address of the instruction represented by the track point. The track point (i.e., branch point) of the branch instruction contains the track address of the branch target instruction of the branch instruction in the track table, and the track address corresponds to the instruction address of the branch target instruction.

For illustrative purposes, BN represents a track address. BNX represents a row number of the track address, and BNY represents a column number of the track address. Thus, track table 2 may be configured as a two dimensional table with X number of rows and Y number of columns, in which each row, addressable by BNX, corresponds to one memory block or memory line, and each column, addressable by BNY, corresponds to the offset of the corresponding instruction within memory blocks. Accordingly, each BN containing BNX and BNY also corresponds to a track point in the track table 2. That is, a corresponding track point can be found in the track table 2 according to one BN.

When an instruction corresponding to a track point is a branch instruction (in other words, the instruction type information of the track point indicates the corresponding instruction is a branch instruction), the track point also stores position information of the branch target instruction of the branch instruction in the memory (i.e. L1 cache 110) that is indicated by a track address. Based on the track address, the position of a track point corresponding to the branch target instruction can be found in the track table 2. For the branch point of the track table 2, the track table address is the track address corresponding to the branch source address, and the content of the track table contains the track address corresponding to the branch target address.

The scanner 121 may examine every instruction sent from external memory to L1 cache 110. If the scanner 121 finds an instruction is a branch instruction, the branch target address of the branch instruction is calculated. For example, the branch target address may be calculated by the sum of the block address of the instruction block containing the branch instruction, the block offset of the instruction block containing the branch instruction, and a branch offset.

The branch target instruction address calculated by the scanner 121 matches with the row address of the memory block stored in the active list 145. If there is a match and the corresponding BNX is found (that is, it indicates that the branch target instruction is stored in L1 cache 110), the active list 145 outputs the BNX to the track table 2. If there is no match (that is, it indicates that the branch target instruction is not stored in L1 cache 110), the branch target instruction address is sent to an external memory. At the same time, one entry is assigned in active list 145 to store the corresponding block address. The BNX is outputted and sent to the track table 2. The corresponding instruction block sent from the external memory is filled to the cache block corresponding to the BNX in L1 cache 110.

When an instruction block outputted from the external memory is filled to a cache block of L1 cache 110, the corresponding track is built in the corresponding row of the track table 2. The branch target instruction address of the branch instruction in the instruction block outputs a BNX after the matching operation is performed in the active list 145. The position of the branch target instruction in the instruction block (i.e. the offset of the branch target instruction address) is the corresponding BNY. Thus, the track address corresponding to the branch target instruction is obtained. The track address as the content of the track point is stored in the track point corresponding to the branch instruction. Thus, a track corresponding to the instruction block is established.

Further, the instruction control unit 12 may also include the tracker 120. Based on the position of the branch instruction stored in the track table 2, the read pointer 131 of the tracker 120 moves from the first branch instruction after the instruction being executed by CPU core 10 in advance, and points to a branch instruction of several levels of branches. Based on the branch instruction pointed to by the read pointer 131 during movement of the read pointer 131 of the tracker 120, the instruction control unit 12 selects the instruction of the corresponding instruction segment and controls L1 cache 110 to provide the selected instruction for CPU core 10.

The read pointer 131 may point to different rows in the track table during movement of the read pointer 131 of the tracker 120. Based on the row of the track table pointed to by the read pointer 131 during movement of the read pointer 131 of the tracker 120, the instruction control unit 12 finds the instruction segment corresponding to L1 cache 110; or based on the track address of the target instruction contained in the table entry of the track table pointed to by the read pointer 131 of the tracker 120, the instruction control unit 12 finds the instruction segment corresponding to L1 cache 110.

FIG. 2 illustrates a structure schematic diagram of an exemplary tracker consistent with the disclosed embodiments. As shown in FIG. 2, the tracker 120 includes two registers. The two registers store the next instruction segment and a track address of a branch instruction of a target instruction segment, respectively. The output of the register 21 is read pointer 19 of the tracker 15. The read pointer 131 of the tracker 120 moves ahead and points to a branch instruction after a level of branch, and selects an instruction based on a prediction bit. When the read pointer 131 of the tracker 120 points to a branch instruction of several levels of branches, the execution process is similar to the process in FIG. 2.

When an instruction type read out from the track table 2 is decoded and a branch instruction type is obtained, the read pointer 131 of the tracker 120 points to a branch instruction (i.e. the value of the read pointer 131 is an instruction address of a branch source). At this time, selector 136 selects the address value of target instruction segment outputted by the track table 2 and stores the address value in register 124. At the same time, the track address value of the next instruction segment is obtained by the track address value of the branch source instruction of the read pointer 131 added 1 by incrementer 140, and the track address value of the next instruction segment is stored in register 123.

Prediction information 125 indicating whether the branch instruction is taken a branch may be also read out from the track table 2. Based on the prediction information 125, selector 136 selects one from the track address value of the next instruction segment stored in register 123 and the track address value of the target instruction segment stored in register 124 as a new read pointer value of the tracker. Thus, read pointer 131 continues to move ahead to control L1 cache 110 to provide the instructions to be executed for CPU core 10 until the read pointer 131 points to a branch instruction.

If prediction information 125 indicates the branch instruction most likely does not take a branch, when the branch instruction is not executed completely, signal 138 controls selector 137 to select prediction information 125 to control selector 139 to select the track address value stored in register 123 as the value of read pointer 131. Thus, read pointer 131 outputs the track address value currently stored in register 123 to L1 cache 110. Based on the track address, L1 cache 110 provides the corresponding instructions (i.e. instructions in the next instruction segment) for CPU core 10 to execute. At the same time, the next track address value of the instruction segment is obtained by the track address value added 1 by incrementer 140, and the next track address value is stored in register 123 (at this time, the value stored in register 124 is kept unchanged), and so forth. Thus, read pointer 131 moves ahead to control L1 cache 110 to provide the instructions to be executed for CPU core 10 until the read pointer 131 points to a branch instruction.

If prediction information 125 indicates the branch instruction most likely takes a branch, when the branch instruction is not executed completely, signal 138 controls selector 137 to select prediction information 125 to control selector 139 to select the track address value stored in register 124 as the value of read pointer 131. Thus, read pointer 131 outputs the track address value currently stored in register 124 to L1 cache 110. Based on the track address, L1 cache 110 provides the corresponding instructions for CPU core 10 to execute. At the same time, the next track address value of the instruction segment is obtained by the track address value added 1 by incrementer 140, and the next track address value is stored in register 124 (at this time, selector 136 selects the output of incrementer 140 to update register 124, and the value stored in register 123 is unchanged), and so on. Thus, read pointer 131 moves ahead to control L1 cache 110 to provide the instructions to be executed for CPU core 10 until the read pointer 131 points to a branch instruction.

When the speculative execution branch instruction is executed completely, signal 138 controls selector 137 to select determination information 126 indicating whether a branch is taken from CPU core 10 to control selector 139. Specifically, if the branch is not taken, the track address value currently stored in register 123 is selected as a new value of read pointer 131; if the branch is taken, the track address value currently stored in register 124 is selected as a new value of read pointer 131. Thus, read pointer 131 can continue to move along the correct track and perform a similar speculative execution for the next branch instruction. At the same time, instruction control unit 12 sends information to CPU core 10 to clear the execution results or intermediate results of the error instruction segment executed by CPU core 10. Specifically, all the instructions in the pipeline after the branch instruction are cleared.

Thus, if the branch prediction is correct, the above described method can eliminate the losses of clock cycle due to time of waiting for a branch judgment. Once the branch prediction is incorrect, the situation when using the above described method is not worse than the situation without speculative execution.

The described prediction bit is a single bit or a plurality of bits, and the initial value of the prediction bit is set to a fixed value or set according to the branch jump direction of a branch instruction.

FIG. 3a illustrates a schematic diagram of an exemplary prediction bit with a single bit consistent with the disclosed embodiments. FIG. 3b illustrates a schematic diagram of an exemplary prediction bit with 2 bits (one of a plurality of bits) consistent with the disclosed embodiments. In addition, the prediction bit can also be three bits, four bits, or even more bits. The initial value of the prediction bit can be set to a fixed value or set according to the branch jump direction of a branch instruction.

There are three initial value set methods for the prediction bit with a single bit. The initial value is set to ‘0’ to indicate that the branch is not taken; the initial value is set to ‘1’ to indicate that the branch is taken; or the initial value is set according to the branch jump direction of a branch instruction. For example, the initial value of the prediction bit of the forward branch instruction is set to ‘0’ to indicate that the branch is not taken, and the initial value of the prediction bit of the backward branch instruction is set to ‘1’ to indicate that the branch is taken. Of course, in other embodiments, the initial value of the prediction bit of the branch instruction can also be set to the opposite value.

Further, based on information whether the branch instruction executed by CPU core 10 takes a branch, the prediction value corresponding to the branch instruction in track table 2 may be revised.

As shown in FIG. 3a, the initial value of the prediction bit of certain branch instruction is set to ‘0’ to indicate that the branch is not taken. When the branch instruction is executed, if the branch is not taken, the prediction bit is kept to ‘0’. When the branch instruction is executed, if the branch is taken, the prediction bit is updated to ‘1’. Then, when the branch instruction is executed, if the branch is taken, the prediction bit is kept to ‘1’; when the branch instruction is executed, if the branch is not taken, the prediction bit is updated to ‘0’.

As shown in FIG. 3b, the prediction bit of certain branch instruction is two bits. The initial value of the prediction bit of the branch instruction is set to ‘00’.

Based on information whether the branch instruction executed by CPU core 10 takes a branch, the prediction value corresponding to the branch instruction may be revised. The prediction bit ‘00’ indicates that the branch is most likely not to be taken. The prediction bit ‘01’ indicates that the branch is likely not to be taken. The prediction bit ‘10’ indicates that the branch is likely to be taken. The prediction bit ‘11’ indicates that the branch is most likely to be taken. Thus, when the branch instruction does not take a branch, the corresponding prediction bit is revised to the status that the branch is most likely not to be taken. When the branch instruction takes a branch, the corresponding prediction bit is revised to the status that the branch is most likely to be taken.

Specially, when read pointer 131 points to the next instruction segment and the next branch instruction of the target instruction segment, read pointer 131 stops to move because the next branch instruction uses the next instruction segment and the track address of the branch instruction segment to update register 123 and register 124. Thus, when the speculation is incorrect and read pointer 131 returns to another instruction segment of the first branch instruction, the address is replaced by the corresponding track address of the next instruction segment (that is, the original address does not exist). A buffer can be used to replace register 123 and register 124 to solve this problem.

FIG. 4a illustrates a structure schematic diagram of a first-in-first-out (FIFO) buffer consistent with the disclosed embodiments. The buffer includes a buffer 223 and a buffer 224. The buffer 223 replaces register 123 shown in FIG. 2. The buffer 224 replaces register 124 shown in FIG. 2. The two buffers have a plurality of cells, a write port and a read port, respectively. The write ports of the two buffers are controlled by the same write pointer 201, and the read ports of the two buffers are controlled by the same read pointer 202.

The input of the buffer connects to the write port. When the track address of the next instruction address of the branch point and the track address of the target instruction segment are respectively written into buffer 223 and buffer 224, the track addresses are written into the cells of buffer 223 and buffer 224 pointed to by the write pointer, respectively. After completing the write operation, the write pointer is added 1 and then points to the next cell. The read pointer always points to the cell containing the track address that is latest written into the buffer (that is, the value of the read pointer is equal to the value of the write pointer decremented by one; or the value of write pointer is equal to the value of the read pointer added by one). The read ports of buffer 223 and buffer 224 of the buffer output the track addresses of the cells pointed to by the read pointer to selector 139 in FIG. 2 for subsequent operations, respectively.

In addition, the buffer also includes a reserve pointer 203 pointing to the cell containing the track address that is the earliest written into the buffer. When branch determination information generated by CPU is the same as the prediction value, the value of the reserve pointer is added 1 and points to the next cell of the buffer (the content of the cell is the currently oldest track address); otherwise, the value of reserve pointer 203 is kept unchanged. When speculative execution is performed because no branch determination information is generated by CPU, the value of the read pointer is kept unchanged; when the branch determination information generated by CPU and the predication value are different, the read pointer is forced to point to the cell pointed to by reserve pointer 203. When the branch determine information generated by CPU and the predication value are different, the write pointer is forced to point to the next cell of the cell pointed to by reserve pointer 203; otherwise, every time a new track address is written into the cell pointed to by the write pointer, the write pointer moves down to the next cell.

FIG. 4b˜4h illustrates operating principle of a buffer consistent with the disclosed embodiments.

FIG. 4b illustrates a schematic diagram of an exemplary prediction and execution of an instruction segment consistent with the disclosed embodiments. As shown in FIG. 4b, an uppercase letter (such as ‘A’, ‘B’, etc.) represents an instruction segment, and a lowercase letter (such as ‘a’, ‘b’, etc.) represents a branch point of the instruction segment (that is, the last instruction of the instruction segment). For example, a branch point ‘a’ belongs to the instruction segment ‘A’; a branch point ‘b’ belongs to the instruction segment ‘B’, and so on. In addition, the left sub-tree of each branch point indicates the next instruction segment of the branch point, and right sub-tree of each branch point indicates the target instruction segment of the branch point. For example, an instruction segment ‘B’ is the next instruction segment of the branch point ‘a’, and an instruction segment ‘C’ is the target instruction segment of the branch point ‘a’, and so on.

It is assumed that the value of the prediction bit of the branch instruction ‘a’ is ‘0’; the value of the prediction bit of the branch instruction ‘b’ is ‘1’; the value of the prediction bit of the branch instruction ‘d’ is ‘1’; the value of the prediction bit of the branch instruction ‘e’ is ‘0’. FIG. 4c˜4h illustrate a structure schematic diagram of the locations pointed to by a read pointer, a writer pointer, and a reserve pointer of buffer 223 and buffer 224 and change situation of cell values of buffer 223 and buffer 224 at different time points consistent with the disclosed embodiments. As shown in FIG. 4c˜4h, for illustration purposes, the cells of buffer 223 and buffer 224 only display the required value. In addition, ‘the track address of the first instruction of instruction segment’ is known simply as ‘the track address of instruction segment’.

When the read pointer of the tracker points to a branch point ‘a’, the track address of the next instruction segment and the track address of the target instruction segment are written to No. 0 cell pointed to by the write pointers of buffer 223 and buffer 224, respectively. At this time, the read pointer points to No. 0 cell. The read ports of buffer 223 and buffer 224 output the track address of the next instruction segment ‘B’ and the track address of the target instruction segment ‘C’ to selector 139, respectively. Because the prediction bit of the branch point ‘a’ is ‘0’, according to the described embodiment in FIG. 2, selector 139 selects the track address from buffers 223. The selected track address is continuously added 1, and the corresponding cell stored in buffer 223 (i.e. No. 0 cell) is updated. The instructions are provided for CPU along the instruction segment ‘B’ until it reaches the next branch point ‘b’.

As shown in FIG. 4c, at this time, both the read pointer and the reserve pointer point to No. 0 cell, and the write pointer points to the No. 1 cell. ‘b’ located in No. 0 cell of buffer 223 indicates that the cell stores the track address of the branch point ‘b’, and ‘C’ located in No. 0 cell of buffer 224 indicates that the cell stores the track address of the branch point ‘C’.

When the read pointer of the tracker points to a branch point ‘b’, the track address of the next instruction segment and the track address of the target instruction segment are written to No. 1 cell pointed to by the write pointers of buffer 223 and buffer 224, respectively. At this time, the read pointer points to No. 1 cell. The read ports of buffer 223 and buffer 224 output the track address of the next instruction segment ‘D’ and the track address of the target instruction segment ‘E’ to selector 139, respectively. Because the prediction bit of the branch point ‘b’ is ‘1’, according to the described embodiment in FIG. 2, selector 139 selects the track address from buffers 224. The selected track address is continuously added 1 and the corresponding cell stored in buffer 223 (i.e. No. 1 cell) is updated. The instructions are provided for CPU along the instruction segment ‘E’ until it reaches the next branch point ‘e’.

As shown in FIG. 4d, at this time, the read pointer points to No. 1 cell; the reserve pointer points to No. 0 cell; and the write pointer points to the No. 2 cell. ‘D’ located in No. 1 cell of buffer 223 indicates that the cell stores the track address of the instruction segment ‘D’, and ‘e’ located in No. 1 cell of buffer 224 indicates that the cell stores the track address of the branch point ‘e’.

When the read pointer of the tracker points to a branch point ‘e’, the track address of the next instruction segment and the track address of the target instruction segment are written to No. 2 cell pointed to by the write pointers of buffer 223 and buffer 224, respectively. At this time, the read pointer points to No. 2 cell. The read ports of buffer 223 and buffer 224 output the track address of the next instruction segment ‘J’ and the track address of the target instruction segment ‘K’ to selector 139, respectively. Because the prediction bit of the branch point ‘e’ is ‘0’, according to the described embodiment in FIG. 2, selector 139 selects the track address from buffers 223. The selected track address is continuously added 1 and the corresponding cell stored in buffer 223 (i.e. No. 2 cell) is updated. The instructions are provided for CPU along the instruction segment ‘J’ until it reaches the next branch point ‘j’.

As shown in FIG. 4e, at this time, the read pointer points to No. 2 cell; the reserve pointer points to No. 0 cell; and the write pointer points to the No. 3 cell. ‘j’ located in No. 2 cell of buffer 223 indicates that the cell stores the track address of the branch point ‘j’, and ‘K’ located in No. 2 cell of buffer 224 indicates that the cell stores the track address of the instruction segment ‘K’.

It is assumed that an execution result of the branch point ‘a’ is generated by CPU and a branch is not taken. That is, when a branch determination result and the prediction value are the same, the value of the reserve pointer is added 1 and the reserve pointer points to No. 1 cell. The value of the read pointer and the write pointer are kept unchanged, as shown in FIG. 4f.

Further, it is assumed that an execution result of the branch point ‘b’ is generated by CPU and a branch is not taken. That is, when a branch determination result and the prediction value are different, the execution results or intermediate results after the branch point ‘b’ in CPU are all cleared. At this time, the value of the reserve pointer is kept unchanged, but the read pointer is forced to point to the cell pointed to by the reserve pointer and the write pointer is forced to point to the cell next to the cell pointed to by the reserve pointer, as shown in FIG. 4g. At this time, both the read pointer and the reserve pointer point to No. 1 cell, and the write pointer points to the No. 2 cell.

Therefore, buffer 223 and buffer 224 output the track address stored in the No. 1 cell to selector 139, respectively. Because the branch determination result indicates that a branch is not taken, selector 139 selects the track address of the cell pointed to by the read pointer from buffers 223 (i.e., the track address of the instruction segment ‘D’ is selected). The selected track address is continuously added 1 and the corresponding cell stored in buffer 223 (i.e. No. 1 cell) is updated. The instructions are provided for CPU along the instruction segment ‘D’ until it reaches the next branch point ‘d’.

When the read pointer of the tracker points to a branch point ‘d’, the track address of the next instruction segment and the track address of the target instruction segment are written to No. 2 cell pointed to by the write pointers of buffer 223 and buffer 224, respectively. At this time, the read pointer points to No. 2 cell. The read ports of buffer 223 and buffer 224 output the track address of the next instruction segment ‘H’ and the track address of the target instruction segment ‘I’ to selector 139, respectively. Because the prediction bit of the branch point ‘d’ is ‘1’, according to the described embodiment in FIG. 2, selector 139 selects the track address from buffers 224. The selected track address is continuously added 1, and the corresponding cell stored in buffer 224 (i.e. No. 2 cell) is updated. The instructions are provided for CPU along the instruction segment ‘I’ until it reaches the next branch point ‘i’.

As shown in FIG. 4h, at this time, the read pointer points to No. 2 cell; the reserve pointer points to No. 1 cell; and the write pointer points to the No. 3 cell. ‘H’ located in No. 2 cell of buffer 223 indicates that the cell stores the track address of the instruction segment ‘H’, and ‘i’ located in No. 2 cell of buffer 224 indicates that the cell stores the track address of the branch point ‘i’.

The next execution process is similar to the above described situation, which is not repeated here. It should be noted that, if the two branch points are adjacent (for example, an instruction segment contains only one instruction), the track address of the instruction segment is the track address of the branch point of the instruction segment. The described method may also be applied to the execution process in this case. A track point in track table 2 can also contain a plurality of groups of prediction bits. Based on branch determination information 126 actually generated by CPU core 10, a group of prediction bits with the highest prediction accuracy rate may be found. Based on a prediction track constituted by the group of prediction bits in continuous different branch instructions, speculative execution is performed to further improve branch prediction accuracy.

FIG. 5a illustrates a structure schematic diagram of an exemplary tracker with a plurality of groups of prediction bits consistent with the disclosed embodiments. As shown in FIG. 5a, the structure of a tracker has 4 groups of prediction bits. The structure of other number of groups of prediction bits is similar to the structure of 4 groups of prediction bits.

FIG. 5b illustrates a schematic diagram of the content of an exemplary track point containing a plurality of groups of prediction bits consistent with the disclosed embodiments. As shown in FIG. 5b, the content of a branch track point contains 4 groups of prediction bits (i.e., PRED A, PRED B, PRED C and PRED D), instruction type 304, and BNX 305 and BNY 306 in the track address. Other modules may be included in the tracker.

Tracker 300 in the present embodiment is basically the same as tracker 120 shown in FIG. 2. The difference is that there are 4 groups of prediction bits value 125 of the branch point outputted from the track table 2, and the prediction bits value is not directly used to select an instruction segment for speculative execution, instead, the prediction bits value is sent to the prediction module 301. Based on the inputted prediction value of a branch point, prediction module 301 generates speculative signal 303 and performs the subsequent speculative execution as shown in FIG. 2. In addition, prediction module 301 also outputs updating selection signal 302 to track table 2 to determine which group of prediction bits value is replaced when prediction bit value of the branch point is replaced based on an actual execution result of the branch instruction executed by CPU.

FIG. 5c illustrates a structure schematic diagram of an exemplary prediction module consistent with the disclosed embodiments. A prediction module 301 includes a buffer unit 310, a comparison unit 311, a counting unit 312, a trace decision unit 313, an accumulation unit 314 and replacement decision logic 315 and a selector 316.

Based on a prediction value, a branch of a branch instruction is executed speculatively before the determination result is generated. Therefore, a FIFO buffer unit 310 is configured to temporarily store the prediction value corresponding to the branch instruction that is speculatively executed, but the branch determination result is not generated.

The buffer unit 310 includes 4 groups of FIFO registers. Every group of FIFO registers corresponds to one group of prediction bits value. Thus, branch determination signal 126 synchronizes with four prediction values outputted by buffer unit 310. That is, every time branch determination signal 126 is generated, the prediction values outputted by buffer unit 310 and branch determination signal 126 belong to the same branch point.

The comparison unit 311 includes 4 groups of comparators. The comparators compare four prediction values outputted by buffer unit 310 with branch determination signal 126 sent from CPU core 10, respectively. The corresponding four comparison results are sent to counting unit 312. For illustrative purposes, when the comparison result indicates that the match is successful, the outputted comparison result is ‘1’; when the comparison result indicates that the match is unsuccessful, the outputted comparison result is ‘0’.

The counting unit 312 includes 4 groups of counting logic. Every group of counting logic receives a comparison result of comparison unit 311, and outputs the counting result indicating the number of ‘1’ in the most recent n times of comparison results, where n is a natural number.

For example, the counting logic can be implemented using a shift register and an adder. When the counting result indicates the number of ‘1’ in most recent 7 times of comparison results, the counting logic can be implemented using a 7-bit shift register and an adder. The input of the shift register is a comparison result outputted by the corresponding comparator in comparison unit 311. The output of the shift register is sent to accumulation unit 314. When comparison unit 311 outputs a new comparison result (that is, when CPU core 10 generates a new branch determination signal 126), the shift register performs a shift operation. Thus, the content stored in the shift register is most recent 7 times of comparison results. Every bit of the shift register is summed using the adder. That is, the number of ‘1’ in most recent 7 times of the comparison results stored in the shift register is obtained. The obtained counting result added by the adder is sent to trace decision unit 313.

Of course, other appropriate apparatus may also implement the above addition functions. For example, an adder with weights may give different weights for data bits of the shift register corresponding to different time points. The weight can be 0, 1, or any other appropriate value. When the weight of a bit is 0, this bit does not participate in sum, thus implementing the adjustable range of the summation. For example, the largest weight can be given for the data bit of the shift register corresponding to the newest prediction bit, and the smaller weight can be given for the data bit of the shift register corresponding to the older prediction bit. At this time, the output of counting unit 312 is a counting result with weights.

The group with the most number of ‘1’ in n most recent times of comparison results is the most accurate group of prediction bits in n most recent times of branch predictions, where n is a nature number. Therefore, the group of prediction bits value that is used as a basis for speculative execution of the later branch point has the highest accuracy. Thus, trace decision unit 313 selects the maximum counting value from 4 counting results sent from counting unit 312 as selection signal 317. Selection signal 317 controls selector 316 to select one of 4 groups of prediction values corresponding to the current branch point as speculative signal 303. Speculative signal 303 is sent to selector 137 of tracker 300 as branch speculative value to control selector 139 to select and generates a new read pointer 131.

In addition, accumulation unit 314 is constituted by 4 special accumulators. Each special accumulator receives a comparison result from the corresponding comparator 311. When the comparison result is ‘1’, the value of the special accumulator is kept unchanged. When the comparison result is ‘0’, the value of the special accumulator increases 1. Thus, each special accumulator of accumulation unit 314 records the number of prediction error of the corresponding prediction bit. Four accumulated values of accumulation unit 314 are outputted to replacement decision logic 315.

When the value of select signal 317 is frequently changed, or continuous n times of 4 comparison results outputted by comparison unit 311 are all ‘0’ (that is, 4 groups of prediction values and branch determination information do not match), it indicates that the current 4 groups of prediction bits cannot accurately speculate the actual situation whether the branch is taken or not. Therefore, one group of prediction value among 4 groups of prediction values needs to be replaced, that is, an actual branch determination result replaces an old value of the group of prediction bits of the corresponding branch instruction. At this time, one group of prediction bits corresponding to the largest one from 4 current accumulated values received by replacement decision logic 315 are selected as the prediction bits to be replaced, and updating selection signal 302 is sent to track table 2 to update the group of prediction bits value corresponding to the branch point with an actual execution result generated by CPU to execute the branch instruction. During this replacement process, accumulation unit 314 does not accumulate comparison results corresponding to the group of prediction bits sent from comparator 311.

Meanwhile, prediction module 301 continues to perform a predict operation. Once a group of prediction bits that can accurately speculate the actual situation whether the branch is taken or not is found, prediction module 301 stops the replacement process and performs other speculative executions based on the group of prediction bits. For example, when the groups of prediction bits as the speculation on whether the branch instruction takes a branch are not frequently changed, prediction module 301 can select one group as a group of prediction bits with a higher prediction accuracy rate and stops the replacement process. When at least one group of prediction bits value in continuous n times of comparison results of prediction module 301 matches with branch determination information, the group of prediction bits value is selected as a group of prediction bits with a higher prediction accuracy rate and the replacement process is stopped.

Thus, based on 4 groups of prediction bits values recorded in track table 2 combined with prediction module 300, the instructions that are most likely to be executed can be speculated in the near future, and based on branch determination information 126 actually generated by CPU core 10, a group of prediction bits with the highest prediction accuracy rate are found. According to the prediction track constituted by the group of prediction bits of continuous different branch instructions, speculative executions are performed. The prediction bits are updated according to actual needs to reach a substantially high branch prediction accuracy rate.

In the instruction processing system provided in the present disclosure, based on the branch prediction bit of the branch instruction stored in a track table, the instruction control unit controls memory system to provide the instructions most likely to be executed for CPU core. A very high branch prediction accuracy rate is achieved with very low hardware costs, thereby improving the performance of the instruction processing system. Other advantages and applications are obvious to those skilled in the art.

The disclosed systems and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed systems and methods may provide fundamental solutions to processing branch instructions for pipelined processors. The disclosed systems and methods obtain addresses of branch target instructions in advance of execution of corresponding branch points and use various branch decision logic arrangements to eliminate the efficiency-loss due to incorrectly predicted branch decisions.

The disclosed devices and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve pipeline efficiency as well as overall system efficiency.

### SEQUENCE LISTING FREE TEXT

Sequence List Text

1. An instruction processing system, comprising:
a central processing unit (CPU) configured to execute one or more instructions of executable instructions;
a memory system configured to store the instructions; and
an instruction control unit configured to, based on location of a branch instruction stored in a track table, control the memory system to provide the instructions to be executed for the CPU, wherein the instruction control unit is further configured to, based on branch prediction of the branch instruction stored in the track table, control the memory system to output one of a fall-through and a target instruction of the branch instruction.

2. The system according to claim 1, wherein:
the instruction control unit further includes a tracker, and the tracker is configured to:
move to a first branch instruction, and based on the branch prediction of the branch instruction;
output one of an address of a fall-through instruction of the branch instruction and an address of a target instruction of the branch instruction to control the memory system to provide the instruction for the CPU; and
store the other one of the address of the fall-through instruction of the branch instruction and the address of the target instruction of the branch instruction.

3. The system according to claim 2, wherein:
the tracker includes at least one register, wherein every register is configured to store one of the address of the fall-through instruction of the branch instruction and the address of the target instruction of the branch instruction.

4. The system according to claim 2, wherein the tracker is further configured to:
receive information on whether the branch instruction takes a branch, and
compare the received information on whether the branch instruction takes a branch with the branch prediction.

5. The system according to claim 4, wherein the tracker is further configured to:
when a comparison result indicates that the received information and the branch prediction are the same, continue to move ahead to the first branch instruction and outputs one of the address of the fall-through instruction of the branch instruction and the address of the target instruction of the branch instruction to control the memory system to provide the instruction for the CPU; and
when the comparison result indicates that the received information and the branch prediction are not the same, clear execution results and intermediate results of all instructions from a prediction execution instruction corresponding to the branch instruction executed by CPU.

6. The system according to claim 5, wherein the tracker is further configured to:
based on a track of the other stored address of the branch instruction, move ahead to the first branch instruction, and
output one of the address of the fall-through instruction of the branch instruction and the address of the target instruction of the branch instruction to control the memory system to provide the instruction for the CPU.

7. The system according to claim 3, further including:
a buffer includes a plurality of registers, storing any one of the address of the fall-through instruction of the corresponding branch instruction or the address of the target instruction of the corresponding branch instruction based on the order of the branch instructions,
wherein the tracker is further configured to:
receives the information on whether the branch instruction takes a branch,
compares the received information on whether the branch instruction takes a branch with the branch prediction,
when a comparison result indicates that the received information and the branch prediction are the same, discard the earliest stored address, to continue to move ahead to the first branch instruction and to output one of the address of the fall-through instruction of the branch instruction and the address of the target instruction of the branch instruction to control the memory system to provide the instruction for the CPU; and
when the comparison result indicates that the received information and the branch prediction are not the same, based on the track of the earliest stored address in the buffer, move ahead to the first branch instruction, to output one of the address of the fall-through instruction of the branch instruction and the address of the target instruction of the branch instruction to control the memory system to provide the instruction for the CPU, and to discard all addresses stored in the buffer before the comparison result is generated.

8. The system according to claim 1, wherein:
the branch prediction includes a single bit prediction value and a plurality of bits prediction value.

9. The system according to claim 8, wherein the instruction control unit is further configured to:
based on the information on whether the branch instruction takes a branch, revise a prediction value corresponding to the branch instruction in the track table.

10. The system according to claim 8, wherein:
an initial value of the branch prediction is set to a fixed value; and
the initial value of the branch prediction is set according to a branch jump direction of the branch instruction.

11. The system according to claim 2, wherein:
the branch prediction includes a plurality of groups of prediction bits.

12. The system according to claim 11, wherein the tracker further includes:
a prediction module configured to compare the received information on whether the branch instruction takes a branch with various groups of prediction bits values corresponding to the branch instruction, respectively.

13. The system according to claim 12, wherein:
the prediction module counts respectively recent n times comparison results for every group of prediction bits, and selects a group of prediction bits with a highest degree of coincidence as speculation of a next prediction branch to output one of the address of the fall-through instruction of the branch instruction and the address of the target instruction of the branch instruction to control the memory system to provide the instruction for the CPU, wherein n is a natural number.

14. The system according to claim 13, wherein:
a range of the recent n times comparison results for every group of prediction bits in the prediction module is adjustable.

15. The system according to claim 13, wherein:
when the prediction module determines that a branch prediction accuracy rate is not high based on an actual execution result of the branch instruction executed by the CPU, the prediction module selects one group of the plurality of groups of prediction bits to replace and writes an actual branch determination result to the group of prediction bits corresponding to the branch instruction, wherein the determination process includes any one of the following conditions:
when the group of prediction bits as the speculation on whether the branch instruction takes a branch are frequently changed, the prediction module determines that the branch prediction accuracy rate is not high; and
when various groups of prediction bits values and branch determination information do not match in continuous k times comparison results of the prediction module, the prediction module determines that the branch prediction accuracy rate is not high, wherein k is a natural number.

16. The system according to claim 15, wherein:
the prediction module counts the number of unmatched results in continuous m times of comparison results, wherein m is a natural number; and
when the prediction bit is replaced, the prediction module selects a group of prediction bits with a largest counting result as a group to be replaced.

17. The system according to claim 13, wherein:
when the prediction module determines that the branch prediction accuracy rate is relatively high based on the actual execution result of the branch instruction executed by the CPU, the prediction module stops the replacement process for the group of prediction bits, wherein the determination process includes any one of the following conditions:
when the group of prediction bits as the speculation on whether the branch instruction takes a branch are not frequently changed, the prediction module determines that the branch prediction accuracy rate is relatively high; and
when at least one group of prediction bits value and the branch determination information match in continuous j times comparison results of the prediction module, the prediction module determines that the branch prediction accuracy rate is relatively high, wherein j is a natural number.

18. An instruction processing method, comprising:
storing instructions in a memory system;
executing one or more instructions of the instructions stored in the memory system; and
based on branch prediction of a branch instruction stored in a track table, controlling the memory system to output one of a fall-through instruction of the branch instruction and a target instruction of the branch instruction.

19. The method according to claim 18, further including:
outputting one of the address of the fall-through instruction of the branch instruction and the address of the target instruction of the branch instruction to control the memory system to provide the instruction for a CPU; and
storing the other one of the address of the fall-through instruction of the branch instruction and the address of the target instruction of the branch instruction.

20. The method according to claim 19, further including:
receiving information on whether the branch instruction takes a branch;
comparing the received information on whether the branch instruction takes a branch with the branch prediction;
when a comparison result indicates that the received information and the branch prediction are the same, moving ahead to a first branch instruction and outputting one of the address of the fall-through instruction of the branch instruction and the address of the target instruction of the branch instruction to control the memory system to provide the instruction for the CPU; and
when the comparison result indicates that the received information and the branch prediction are not the same, clearing execution results and intermediate results of all instructions from a prediction execution instruction corresponding to the branch instruction executed by the CPU.

21. The method according to claim 20, further including:
based on a track of the other stored address of the branch instruction, moving ahead to the first branch instruction, and outputting one of the address of the fall-through instruction of the branch instruction and the address of the target instruction of the branch instruction to control the memory system to provide the instruction for the CPU.

22. The method according to claim 18, wherein:
the branch prediction includes any one of a single bit prediction value and a plurality of bits prediction value.

23. The method according to claim 18, further including:
based on the information on whether the branch instruction takes a branch, revising a prediction value corresponding to the branch instruction in the track table.

24. The method according to claim 18, wherein:
the branch prediction includes a plurality of groups of prediction bits.

25. The method according to claim 24, further including:
receiving the information on whether the branch instruction takes a branch; and
comparing the received information on whether the branch instruction takes a branch with various groups of prediction bits values corresponding to the branch instruction, respectively.

26. The method according to claim 25, further including:
counting respectively recent n times comparison results for every group of prediction bits, wherein n is a natural number;
selecting a group of prediction bits with a highest degree of coincidence as speculation of a next prediction branch;
outputting one of the address of the fall-through instruction of the branch instruction and the address of the target instruction of the branch instruction; and
controlling the memory system to provide the instruction for the CPU.

27. The method according to claim 26, wherein:
when the prediction module determines that a branch prediction accuracy rate is not substantially high based on an actual execution result of the branch instruction executed by the CPU, the prediction module selects one group of the plurality of groups of prediction bits to replace and writes an actual branch determination result to the group of prediction bits corresponding to the branch instruction, wherein the determination process includes any one of the following conditions:
when the group of prediction bits as the speculation on whether the branch instruction takes a branch are frequently changed, determining that the branch prediction accuracy rate is not substantially high; and
when various groups of prediction bits values and branch determination information do not match in continuous k times comparison results of the prediction module, determining that the branch prediction accuracy rate is not substantially high, wherein k is a natural number.

28. The method according to claim 26, further including:
when determining that the branch prediction accuracy rate is substantially high based on the actual execution result of the branch instruction executed by the CPU, stopping the replacement process for the group of prediction bits, wherein the determination process includes any one of the following conditions:
when the group of prediction bits as the speculation on whether the branch instruction takes a branch are not frequently changed, determining that the branch prediction accuracy rate is substantially high; and
When at least one group of prediction bits value and the branch determination information match in continuous j times comparison results of the prediction module, determining that the branch prediction accuracy rate is substantially high, wherein j is a natural number.
